(19) United States
(12) Patent Application Publication
(10) Pub. No.: US 2025/0173045 A1
(43) Pub. Date: May 29, 2025

(54) BOOK INFORMATION DISPLAY METHOD AND APPARATUS, DEVICE, AND STORAGE MEDIUM

(71) Applicant: Beijing Zitiao Network Technology Co., Ltd., Haidian District, Beijing (CN)

(72) Inventors: Wenchang HUANG, Beijing (CN); Rongqiang HUANG, Beijing (CN)

(21) Appl. No.: 18/836,541

(22) PCT Filed: Jul. 31, 2023
(86) PCT No.: PCT/CN2023/110276

§ 371 Date: Aug. 7, 2024

(30) Foreign Application Priority Data
Aug. 9, 2022 (CN) 202210952022.2

(51) Int. Cl. G06F 3/0483

(52) U.S. Cl. CPC G06F 3/0483

(57) ABSTRACT

The present disclosure relates to a book information display method and apparatus, a device and a storage medium. The method comprises: in response to a target trigger operation, displaying a table of content page of a book; in response to detecting that a first chapter and a second chapter of the book which have chapter progresses are not consecutive chapters, determining chapter key information corresponding to a third chapter, the third chapter being an non-started chapter between the first chapter and the second chapter, and the chapter key information comprising information which is extracted from third chapter information of the third chapter and is associated with the first chapter and the second chapter; and displaying on the table of content page the chapter key information of the third chapter.

### CROSS-REFERENCE TO RELATED APPLICATIONS

The present disclosure is based on and claims the priority to the Chinese Patent Application No. 202210952022.2 filed on Aug. 9, 2022, the disclosure of which is incorporated by reference herein in its entirety.

### TECHNICAL FIELD

The present disclosure relates to the technical field of electronic reading, and in particular, to a book information display method and apparatus, a device, and a storage medium.

### BACKGROUND

In the process that a user reads a book through a book application, chapter skip reading will possibly occur. For example, the user reads part of content of chapter 3, then jumps to chapter 10 for reading, and so on.

In view of discontinuity of the content of the book caused by chapter skip reading, as the number of times of chapter skip reading increases, discontinuity in the user's reading of the content of the book increases, so that the user gradually loses the reading interest in the book, even the user abandons the book, reducing the probability of reading the book and the reading experience of the user.

### SUMMARY

In order to solve the above technical problem, the present disclosure provides a book information display method and apparatus, a device and a storage medium.

In a first aspect, the present disclosure provides a book information display method, comprising:
presenting a table of content page of a book in response to a target trigger operation;
in response to detecting that a first chapter and a second chapter in the book which have chapter progresses are not consecutive, determining chapter key information corresponding to a third chapter; wherein the third chapter is an unstarted chapter between the first chapter and the second chapter, and the chapter key information comprises information extracted from third chapter information of the third chapter and associated with the first chapter and the second chapter; and
displaying the chapter key information of the third chapter in the table of content page.

In a second aspect, the present disclosure provides a book information display apparatus, comprising:
a table of content page presentation module, configured to present a table of content page of a book in response to a target trigger operation; a chapter key information determination module, configured to, in response to detecting that a first chapter and a second chapter in the book which have chapter progresses are not consecutive, determine chapter key information corresponding to a third chapter; wherein the third chapter is an unstarted chapter between the first chapter and the second chapter, and the chapter key information comprises information extracted from third chapter information of the third chapter and associated with the first chapter and the second chapter; and
a chapter key information display module, configured to display the chapter key information of the third chapter in the table of content page.

In a third aspect, the present disclosure provides an electronic device, comprising:
a processor;
a memory configured to store executable instructions;
wherein, the processor is configured to read the executable instructions from the memory and execute the executable instructions to implement the book information display method described by any embodiment of the present disclosure.

In a fourth aspect, the present disclosure provides a computer-readable storage medium storing a computer program which, when executed by a processor, causes the processor to implement the book information display method described by any embodiment of the present disclosure.

In a fifth aspect, the present disclosure provides a computer program product comprising: instructions which when executed by a processor, cause the processor to implement the book information display method described by any embodiment of the present disclosure.

In a sixth aspect, the present disclosure provides a computer program product comprising: instructions which when executed by a processor, cause the processor to implement the book information display method described by any embodiment of the present disclosure.

### BRIEF DESCRIPTION OF THE DRAWINGS

The above and other features, advantages, and aspects of embodiments of the present disclosure will become more apparent by referring to the following DETAILED DESCRIPTION when taken in conjunction with the accompanying drawings. Throughout the drawings, the same or similar reference numbers refer to the same or similar elements. It should be understood that the drawings are schematic and that elements and components are not necessarily drawn to scale.

FIG. 1 is a schematic flowchart of a book information display method according to some embodiments of the present disclosure;

FIG. 2 is a schematic display diagram of a first content page according to some embodiments of the present disclosure;

FIG. 3 is a schematic display diagram for displaying chapter key information and local key information in a table of content page according to some embodiments of the present disclosure;

FIG. 4 is a schematic display diagram for displaying a keyword control corresponding to chapter key information and local key information in a table of content page according to some embodiments of the present disclosure;

FIG. 5 is a schematic display diagram of chapter key information and local key information after triggering a keyword control according to some embodiments of the present disclosure;

FIG. 6 is another schematic display diagram of chapter key information after triggering a keyword control according to some embodiments of the present disclosure;

FIG. 7 is a schematic display diagram of a second content page and a return control according to some embodiments of the present disclosure;

FIG. 8 is a schematic structural diagram of a book information display apparatus according to some embodiments of the present disclosure;

FIG. 9 is a schematic structural diagram of an electronic device according to some embodiments of the present disclosure.

### DETAILED DESCRIPTION

The embodiments of the present disclosure will be described in more detail below with reference to the accompanying drawings. While certain embodiments of the present disclosure are shown in the drawings, it should be understood that the present disclosure may be embodied in various forms and should not be construed as limited to the embodiments set forth herein, but rather these embodiments are provided for a more complete and thorough understanding of the present disclosure. It should be understood that the drawings and the embodiments of the present disclosure are for illustration purposes only and are not intended to limit the scope of the present disclosure.

It should be understood that various steps recited in method embodiments of the present disclosure may be performed in a different order, and/or performed in parallel. Moreover, the method embodiments may include additional steps and/or omit performing the illustrated steps. The scope of the present disclosure is not limited in this respect.

The term “including” and variations thereof as used herein are intended to be open-ended, i.e., “including but not limited to”. The term “based on” is “based at least in part on”. The term “one embodiment” means “at least one embodiment”; the term “another embodiment” means “at least one additional embodiment”; the term “some embodiments” means “at least some embodiments”. Relevant definitions for other terms will be given in the following description.

It should be noted that the concepts “first”, “second”, and the like mentioned in the present disclosure are only used for distinguishing different devices, modules or units, and are not used for limiting the order or interdependence of the functions performed by the devices, modules or units.

It is noted that the modifiers “a” or “an” mentioned in this disclosure are intended to be illustrative rather than limiting, and that those skilled in the art will appreciate that they should be understood as “one or more” unless the context clearly indicates otherwise.

The names of messages or information exchanged between devices in the embodiments of the present disclosure are for illustrative purposes only, and are not intended to limit the scope of the messages or information.

The book information display method and apparatus, device and storage medium according to the embodiments of the present disclosure can determine the user has skipped a chapter in reading/listening when detecting that a first chapter and a second chapter having chapter progresses in a book are not consecutive, then determine chapter key information of an unstarted chapter between the first chapter and the second chapter, that is able to be associated with the first chapter and the second chapter, and display the chapter key information at a display position corresponding to a third chapter in the table of content page, so as to present to the user the chapter key information in the skipped third chapter which is associated with the read/listened first chapter and second chapter, improving information exposure rate of the skipped third chapter, also improving continuity of book content to a certain extent, thereby improving the user's interest in the skipped third chapter, and further improving the probability of continuously reading the book and the user experience.

The book information display method according to embodiments of the present disclosure can be applied to a scene of displaying a book table of content in a book application, and is particularly suitable for a scene of displaying a book table of content under the condition that an electronic book is read/listened with chapter skip. The method may be performed by a book information display apparatus, and the apparatus may be implemented by software and/or hardware, and may be integrated in an electronic device installed with a book application. The electronic device may include, but is not limited to, a smart phone, a Personal Digital Assistant (PDA), a Tablet Personal Computer (Tablet PC), a Portable Multimedia Player (PMP), a wearable device, a notebook computer, a desktop computer, and the like.

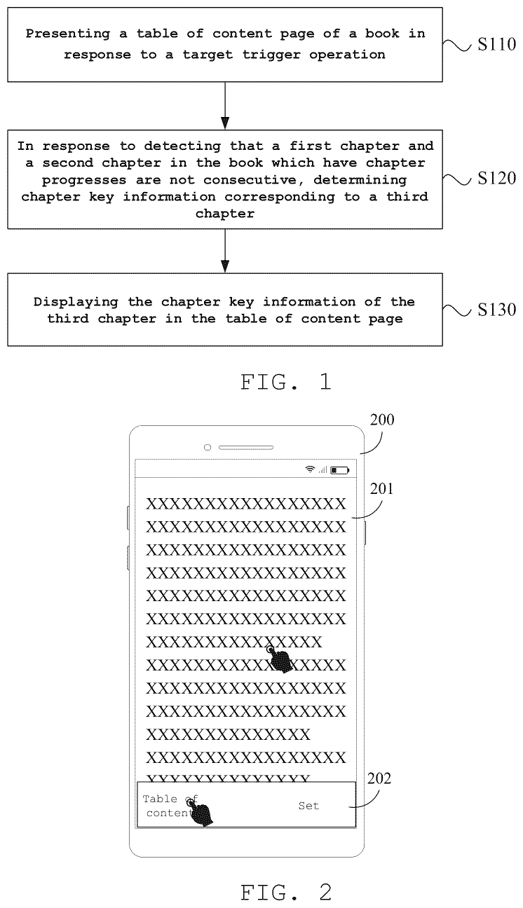

FIG. 1 shows a schematic flowchart of a book information display method according to some embodiments of the present disclosure. As shown in FIG. 1, the book information display method may comprises the steps of:

S110, presenting a table of content page of a book in response to a target trigger operation.

The target trigger operation is an interactive trigger operation for triggering presenting a book table of content. The trigger operation may be, for example, a contact-type interactive operation such as a click or a touch, or a non-contact-type interactive operation such as a voice control or an eye movement control. The table of content page is a page at least for presenting information for book table of content.

Specifically, a user may perform a target trigger operation on a book application presented by an electronic device. Therefore, after the electronic device detects the target trigger operation, a table of content page of a book can be presented.

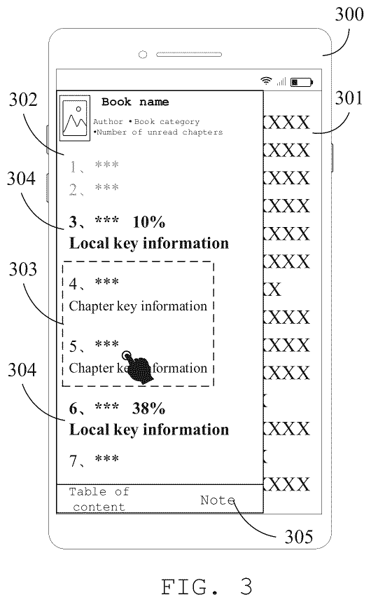

In some embodiments, referring to FIG. 2, the electronic device 200 presents a first content page 201 corresponding to chapter content of a chapter in a book. When the user performs a trigger operation on any position on the first content page 201, the electronic device 200 displays function controls at least including a “table of content” function in a peripheral region (e.g., a bottom region 202) of the first content page 201. When the user performs a trigger operation on the “table of content” function control, the electronic device 200 presents a table of content page on the basis of the first content page 201.

In other embodiments, the electronic device presents overview information (e.g., book introduction, comments, etc.) corresponding to the book, and presents the “table of content” function control in a page where the overview information is located. After the user performs a trigger operation on the “table of content” function control, the electronic device presents the table of content page on the basis of the overview information page or in a new page.

In still other embodiments, the electronic device may also directly display the table of content page when the book is reopened, so that the user can review the book content through the table of content.

S120, in responding to detecting that a first chapter and a second chapter in the book which have chapter progresses are not consecutive, determining chapter key information corresponding to a third chapter.

The chapter progress refers to a progress that a chapter in a book is read or listened, and may be, for example, a progress percentage, a page number ratio, or the like. The first chapter and the second chapter are two different chapters in the book. The third chapter is another chapter in the book which is different from the first chapter and the second chapter, and the third chapter is an unstarted chapter between the first chapter and the second chapter. For example, the first chapter and the second chapter are chapter 3 and chapter 10, respectively, parts of which have been read by the user, and the third chapter may be chapter 6, which has not been read by the user, and so on. The chapter key information refers to information extracted from various related information (i.e., chapter information) such as content, comments, notes, and secondary creation of a chapter, and associated with chapter information of other chapters. In conjunction with the foregoing description, the chapter key information in some embodiments of the present disclosure includes information extracted from chapter information of the third chapter (i.e., third chapter information) and associated with the first chapter and the second chapter.

Specifically, in the process of reading or listening to a book, users may skip a chapter. In this case, the user cannot know related information of the skipped chapter, and thus cannot obtain consecutive book content, as a result, the user may miss some wonderful plots, and even the user's interest in the book is decreased. Based on this, in some embodiments of the present disclosure, chapter key information of the skipped chapter may be presented in the table of content page.

In a specific implementation, the electronic device may, in the process of a user reading/listening to a book, record a chapter progress of each chapter read/listened by the user at the last read/listen. Therefore, the electronic device can acquire the chapter progress of each chapter contained in the book in the process of presenting the table of content page. Then, for any two adjacent chapters having chapter progresses, i.e., a first chapter and a second chapter, the electronic device may determine whether the two chapters are consecutive chapters. If so, it continues to process a next set of adjacent chapters. If not, this shows that chapter skip exists between the first chapter and the second chapter. At this time, the electronic device may acquire chapter key information corresponding to a third chapter, so as to subsequently present to the user, in the table of content page, association information with the skip-read/listened first chapter and second chapter, in the skipped third chapter.

In an implementation, the chapter key information is acquired by pulling by the electronic device from a server. For example, the server may determine the chapter skip condition by itself, and generate chapter key information of the third chapter according to the first chapter and the second chapter before and after the chapter skip. In this way, the electronic device can directly request the chapter key information of the third chapter from the server according to the first chapter, the second chapter and the third chapter. For another example, the electronic device may send a request to generate the chapter key information to the server. After receiving the request, the server generates the chapter key information of the third chapter according to the first chapter and the second chapter corresponding to the request, and feeds back the chapter key information to the electronic device.

In another implementation, the chapter key information is acquired by: the electronic device acquiring chapter information of the first chapter, the second chapter and the third chapter, and generating the chapter key information according to the chapter information.

In some embodiments, the determining chapter key information corresponding to the third chapter comprises: acquiring first chapter information of the first chapter, second chapter information of the second chapter and third chapter information of the third chapter; extracting, from the third chapter information, target information having an association with the first chapter information and the second chapter information, and generating the chapter key information based on the target information.

Specifically, the electronic device may respectively acquire the chapter information corresponding to the first chapter, the second chapter, and the third chapter, namely, the first chapter information, the second chapter information, and the third chapter information. Then, according to a rule that the chapter key information of the third chapter shall be associated with the first chapter and the second chapter, information of commonality or difference between the first chapter information and the second chapter information is first extracted from the two respectively. Thereafter, the electronic device, according to the obtained commonality or difference information, extracts information related thereto from the third chapter information as the target information. And, the electronic device may condense the target information to obtain the chapter key information.

In some embodiments, the extracting, from the third chapter information, the target information having the association with the first chapter information and the second chapter information, comprises: respectively extracting, from the first chapter information and the second chapter information, first information and second information corresponding to a target information dimension; and extracting, from the third chapter information, the target information for transitioning the first information to the second information.

The target information dimension is a preset information dimension for extracting and displaying information from the chapter information. The target information dimension comprises at least one of core content of a chapter, roles contained in the chapter, plots involved in the chapter, events involved in the chapters, scenes corresponding to the events, comments/secondary creations corresponding to the chapter, or the like.

Specifically, the electronic device can determine the target information dimension according to the user's reading interest. For example, the electronic device may determine, according to information such as comments, notes, secondary creations, book category and the like corresponding to the book, which information dimension in the book is more focused by a plurality of users/the current user, and determine at least one determined information dimension as the target information dimension. Then, the electronic device extracts the first information from the first chapter information and extracts the second information from the second chapter according to the target information dimension. Thereafter, the electronic device extracts information corresponding to the difference information between the first information and the second information from the third chapter information as the target information, according to a rule that the target information shall transition the first information to the second information.

In some embodiments, when the target information dimension is a role, the electronic device extracts a first role involved in the first chapter from the first chapter information and a second role involved in the second chapter from the second chapter information. The electronic device then compares the first role and the second role to determine a new role appearing in the second chapter relative to the first chapter. Thereafter, the electronic device may extract information related to the new role from the third chapter as the target information.

In other embodiments, when the target information dimension is a plot (or event, scene), the electronic device may extract a corresponding first plot (or event, scene) from the first chapter information and a corresponding second plot (or event, scene) from the second chapter information. Then, the electronic device determines from the third chapter information whether there is a transition plot (or event, scene) for transitioning the first plot (or event, scene) to the second plot (or event, scene). If not, the target information corresponding to the target information dimension is null; if so, the transition plot (or event, scene) is taken as the target information.

In still other embodiments, when the target information dimension is comment/secondary creation/author message, popular comment/popular secondary creation/author message in the third chapter information can be directly taken as the target information; or the popular comment/popular secondary creation/author message can be first extracted from the first chapter information and the second chapter information, and then the popular comment/popular secondary creation/author message associated with the extracted information can be extracted from the third chapter information as the target information.

In still other embodiments, when there are multiple target information dimensions, the target information corresponding to each target information dimension can be extracted according to the processes of the above examples, and the target information is further condensed to obtain the chapter key information.

S130, displaying the chapter key information of the third chapter in the table of content page.

Specifically, after the electronic device obtains the chapter key information, the chapter key information is displayed at a display position corresponding to the third chapter in the table of content page. In this way, the user can see the key information of the skipped third chapter through the table of content page, and can link the key information with the read/listened first chapter and second chapter, which can not only increase the continuity of the read/listened book content, but also increases the user's reading interest in the skipped chapter to a certain extent, thereby improving the user's reading interest in the book.

In some embodiments, S130 comprises: in the table of content page, zooming in a table of content display area corresponding to the third chapter, and displaying the chapter key information in the zoomed-in table of content display area.

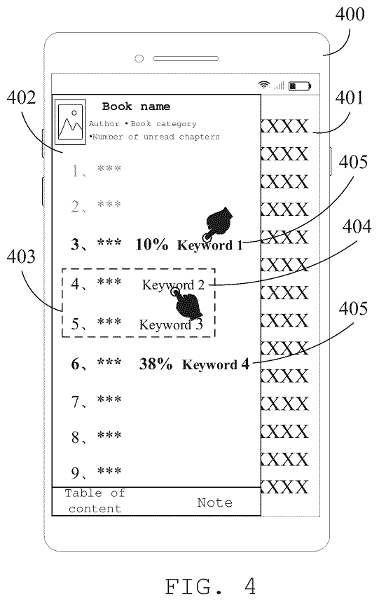

Specifically, referring to FIG. 3, the electronic device 300 displays a table of content page 302 on the basis of a reading page 301. In the table of content page 302, the electronic device 300 displays chapter table of content information for each chapter in the book, for example including at least a chapter number and/or a chapter title. For the skipped third chapter, because more content shall be displayed for the third chapter and a height or length of a display area for the chapter table of content information is limited, the electronic device 300 may increase the height or length of the table of content display area corresponding to the third chapter, and display the chapter key information corresponding to the third chapter in the zoomed-in table of content display area. As shown in in FIG. 3, for the third chapter 303 with chapter numbers of four and five, the electronic device 300 increases the height of its corresponding table of content display area to display the chapter key information corresponding to the third chapter 303.

In other embodiments, S130 comprises: displaying a keyword control corresponding to the chapter key information in the table of content display area corresponding to the third chapter of the table of content page; and in response to a trigger operation on the keyword control, displaying the chapter key information in a target area corresponding to the table of content display area.

The target area comprises a floating window, a floating layer region or the table of content display area expanded along a preset direction.

Specifically, when the electronic device displays the chapter key information, the electronic device may also extract keywords with relatively less content from the chapter key information, display the keywords corresponding to the third chapter in the table of content display area with an original height and length in the table of content page, and set these keywords as interactive controls, that is, display the keyword controls in the table of content display area in the table of content page.

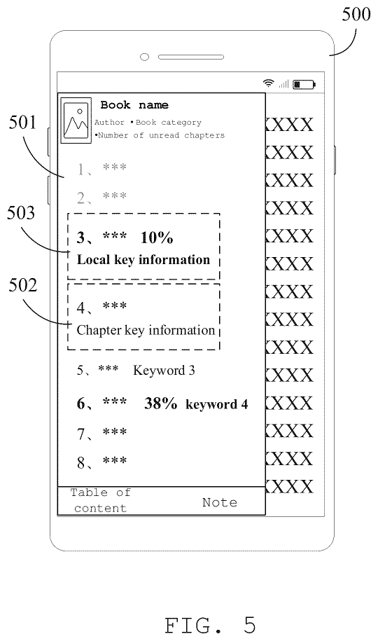

Referring to FIG. 4, an electronic device 400 displays a table of content page 402 based on a reading page 401. In the table of content page 402, the electronic device 400 displays chapter table of content information for each chapter in the book, for example including at least a chapter number and/or a chapter title. For the skipped third chapter 403, the electronic device 400 displays a keyword control 404 corresponding to the chapter key information in its table of content display area.

After the user triggers the keyword control, the electronic device, in response to the trigger operation, displays the chapter key information corresponding to the triggered keyword control in the target area corresponding to the table of content display area.

In some embodiments, after detecting a user's trigger operation on the keyword control 404 displaying text “keyword 2”, the electronic device 400 may expand the table of content display area corresponding to the third chapter with the chapter number “4” downward, to increase the display height of the table of content display area, and present the chapter key information corresponding to the keyword control 404 in the expanded table of content display area, where the display effect may be shown as in FIG. 5. In FIG. 5, an electronic device 500 displays chapter key information corresponding to the third chapter with the chapter number “4” in a height-increased table of content display area 502 in a table of content page 501.

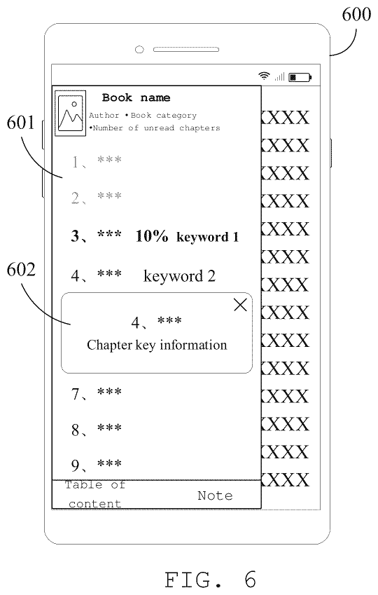

In other embodiments, after detecting the user's trigger operation on the keyword control 404 displaying text “keyword 2”, the electronic device 400 may create a floating window, display the floating window in a peripheral region (e.g., a lower region) of the table of content display area corresponding to the third chapter with the chapter number “4”, and present the chapter key information corresponding to the keyword control 404 in the floating window, where the display effect may be as shown in FIG. 6. In FIG. 6, an electronic device 600 displays chapter key information corresponding to the third chapter with the chapter number “4” in a floating window 602 in a table of content page 601.

The book information display method according to the embodiment of the present disclosure can determine that the user has skipped a chapter in reading/listening when detecting that a first chapter and a second chapter having chapter progresses in a book are not consecutive, then determine chapter key information of an unstarted chapter between the first chapter and the second chapter, which is able to be associated with the first chapter and the second chapter, and display the chapter key information at a display position corresponding to a third chapter in the table of content page, so as to present to the user the chapter key information in the skipped third chapter, which is associated with the read/listened first chapter and second chapter, improving information exposure rate of the skipped third chapter, also improving continuity of book content to a certain extent, thereby improving the user's interest in the skipped third chapter, and further improving the probability of continuously reading the book and the user experience.

In some embodiments, after S110, the book information display method further comprises: acquiring local key information of a target chapter; and displaying a chapter progress and the local key information of the target chapter in the table of content page.

The local key information is information extracted from chapter information corresponding to uncompleted content of the target chapter. For example, the local key information may be core content, highlights, popular comments, etc. The highlight information can be key events, important roles, important time points and the like which influence the trend of following plots. The target chapter includes at least one of the first chapter and the second chapter.

Specifically, for target chapter such as the first chapter or the second chapter, which has chapter progresses but is not completed, in order to increase the user's interest in the content of the uncompleted chapters and to increase the probability that the target chapter is continuously read, the electronic device may extract the local key information from chapter information corresponding to the uncompleted content in the target chapter according to the target information dimension, and then, display the local key information and the chapter progress of the target chapter in a table of content display area corresponding to the target chapter of the table of content page.

As shown in FIG. 3, the electronic device 300 displays chapter progresses and local key information 304 of the target chapters with chapter numbers “3” and “6” in zoomed-in table of content display areas, in the table of content page 302.

As shown in FIG. 4, the electronic device 400 may also extract keywords from the local key information of the target chapters with the chapter numbers “3” and “6”, and display the chapter progresses corresponding to the target chapters and keyword controls 405 in the table of content page 402. When it is detected that the user's trigger operation on the keyword control 405 displaying text “keyword 1”, the electronic device zooms in the table of content display area corresponding to the target chapter with the chapter number “3”, and displays local key information corresponding to the keyword control 405 in the zoomed-in table of content display area, as shown in FIG. 5. In FIG. 5, the electronic device 500 displays the chapter progress and the local key information corresponding to the target chapter with the chapter number “3” in the height-increased table of content display area 503 in the table of content page 501.

It can be understood that, after the user's trigger operation on the keyword control 405 displaying text “keyword 1” is detected, the electronic device may also create a floating window or a floating layer region in the table of content page to display the chapter progress and the local key information corresponding to the target chapter with the chapter number “3”.

In some embodiments, the electronic device presents the table of content page in response to a trigger operation on a table of content control displayed in a first content page, which can see the related description in S110.

On the basis of the above embodiments, after S130, the book information display method further comprises: displaying a second content page in response to a trigger operation on the table of content page, and displaying a return control at a preset position of the second content page; and redisplaying the first content page in response to a trigger operation of the return control.

Wherein, the second content page is another display page of book content, which is different from a display page of chapter content before opening the table of content page (i.e., the first content page). The preset position is a preset display position in the second content page, and may be, for example, a middle area where the user's sight is concentrated, or a peripheral region of the page, such as a top region and a bottom region. The return control is an interactive control for controlling the return of the content page corresponding to the chapter progress stored last time.

Specifically, when the user triggers to enter the table of content page, the electronic device may record a chapter progress of a chapter read/listened before entering the table of content page. When the user performs a trigger operation such as chapter skip or note browsing through the table of content page, the electronic device will display the second content page in response to the trigger operation. At this time, considering that the user may browse the second content page only for a short time or perform a wrong operation, the electronic device may display a return control at a preset position of the second content page, to provide the user with an interactive function of returning to the first content page before entering the table of content page, so that the user can quickly return to the original reading/listening position.

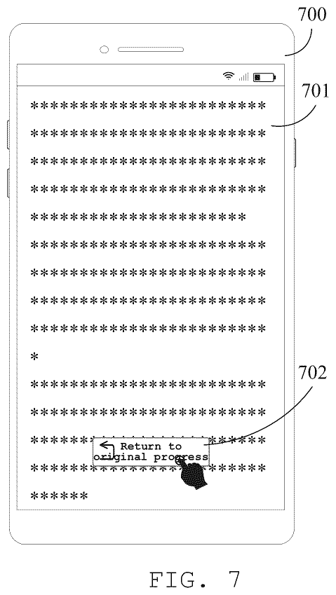

Referring to FIG. 3, after the user performs a trigger operation on table of content information with chapter number “5” in the table of content page 302, the electronic device may display a second content page of the chapter with the chapter number “5” in response to the trigger operation, as shown in FIG. 7. In FIG. 7, an electronic device 700 displays a second content page 701 of a chapter with chapter number “5”, and displays a return control 702 in a bottom region of the second content page 701. The return control 702 hovers over the chapter content in an overlapping manner and does not trigger re-typesetting of the chapter content.

After the user performs a trigger operation on the return control 702, the electronic device 700, in response to the trigger operation, obtains a latest chapter progress before entering the table of content page, and jumps to a corresponding first content page according to the chapter progress, for example, the electronic device redisplays the first content page 201 shown in FIG. 2.

In some embodiments, the displaying the second content page in response to the trigger operation on the table of content page comprises: displaying the second content page corresponding to the triggered chapter in response to a trigger operation on any chapter in the table of content page.

Specifically, the electronic device may, in response to a trigger operation of the user for triggering any chapter in the table of content page, display a second content page where the book content of the triggered chapter is located according to the chapter progress of the triggered chapter.

In some further embodiments, the displaying the second content page in response to the trigger operation on the table of content page comprises: displaying at least one note content corresponding to the book in response to a trigger operation on a note control displayed in the table of content page; and displaying the second content page corresponding to the triggered note content in response to a trigger operation on the note content.

Specifically, referring to FIG. 3, the electronic device 300 also displays a note control 305 in the table of content page 302. The user can display note content corresponding to the book or the chapter before entering the table of content page by a trigger operation on the note control 305. If the user performs a trigger operation on any note content, the electronic device may locate the book content corresponding to the note content in the book, and display a second content page where the located book content is located.

In some embodiments, after displaying the second content page in response to the trigger operation on the table of content page and displaying the return control at the preset position of the second content page, the book information display method further comprises: if no trigger operation on the return control is detected within a preset duration, hiding the return control.

The preset duration is a preset time period, and can be set empirically, or set according to a reflection duration of the user on the displayed control, a reading/listening speed of the user on the part of the book content before the return control, and the like.

Specifically, after the electronic device displays the return control in the second content page, if the user's trigger operation on the return control is not detected within the preset duration, it may be considered that the user does not want to return to the book position before the table of content page, then in order not to affect the user from reading the book content displayed in the second content page, the electronic device may hide the return control.

In some embodiments, after S110, the book information display method further comprises: if it is determined that a chapter progress of any chapter in the book is a completed progress, determining a table of content display style to be a first display style; if it is determined that the chapter progress of any chapter is an intermediate progress that has been started but not completed, determining the table of content display style to be a second display style; if it is determined that any chapter does not have a chapter progress, determining the table of content display style to be a third display style; wherein, in the table of content page, any chapter is displayed in the table of content display style.

The first display style, the second display style and the third display style all are preset display styles of the table of content information, and highlighting effects of the second display style, the third display style and the first display style decreases successively, namely, the second display style is the most highlighted and obvious display style, and the first display style is the least highlighted display style.

Specifically, when displaying the table of content page, the electronic device can determine a display style of table of content information of a certain chapter according to the completion condition of the user on the chapter, and display the table of content of each chapter according to the determined display style.

When the electronic device fails to acquire a chapter progress of a chapter, it may be considered that the user does not start the chapter. At this time, the electronic device determines whether the chapter has corresponding chapter key information through the above embodiments. If not, a table of content display style of the chapter may be determined as a third display style of table of content information displaying chapter number and/or chapter title, such as a black non-bold text style of chapter title, where the display effect may be seen in the table of content information with chapter number “7” in FIG. 3. If the chapter has corresponding chapter key information, the table of content display style of the chapter may be determined as a third display style of table of content information that displays the chapter key information and at least one of the chapter number and the chapter title, such as a black non-bold text style of chapter number, chapter title, chapter key information, where the display effect may be seen in the table of content information with chapter numbers “4” and “5” in FIG. 3.

When the electronic device acquires the chapter progress of a certain chapter and the chapter progress is not a completed progress (e.g., 100%), that is, the chapter progress is an intermediate progress (e.g., with value in a (0% and 100%) interval) of started-but-not-completed chapter content, it may be considered that the user is likely to continue the chapter, and then the table of content display style of the chapter can be determined as a second display style, such as a black bold text style of chapter title, chapter progress and local key information, where the display effect can be seen in the table of content information with chapter numbers “3” and “6” in FIG. 3.

When the electronic device acquires the chapter progress of a certain chapter and the chapter progress is a completed progress (e.g., 100%), it may be considered that the user has read/listened the chapter, and then the table of content display style of the chapter may be determined as a first display style, for example, a gray non-bold text style of chapter title, where the display effect may be seen in the table of content information with chapter numbers “1” and “2” in FIG. 3.

The following are embodiments of the book information display apparatus provided in some embodiments of the present disclosure, which belong to the same inventive concept as the book information display methods in the above embodiments, and reference may be made to the embodiments of the book information display method for details that are not described in detail in the embodiments of the book information display apparatus.

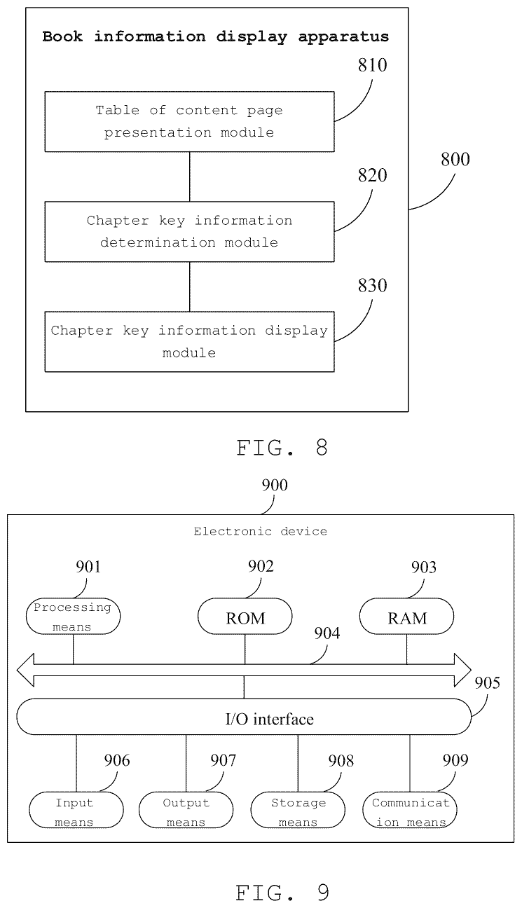

FIG. 8 shows a schematic structural diagram of a book information display apparatus according to some embodiments of the present disclosure. As shown in FIG. 8, the book information display apparatus 800 may comprise:

a table of content page presentation module 810, configured to present a table of content page of a book in response to a target trigger operation; a chapter key information determination module 820, configured to, if it is detected that a first chapter and a second chapter in the book which have chapter progresses are not consecutive, determine chapter key information corresponding to a third chapter; wherein the third chapter is an unstarted chapter between the first chapter and the second chapter, and the chapter key information comprises information extracted from third chapter information of the third chapter and associated with the first chapter and the second chapter; and a chapter key information display module 830, configured to display the chapter key information of the third chapter in the table of content page.

The book information display apparatus according to the embodiment of the present disclosure can determine the user has skipped a chapter in reading/listening when detecting that the first chapter and the second chapter having chapter progresses in the book are not consecutive, then determine chapter key information of an unstarted chapter between the first chapter and the second chapter, which is able to be associated with the first chapter and the second chapter, and display the chapter key information at a display position corresponding to a third chapter in the table of content page, so as to present to the user the chapter key information in the skipped third chapter, which is associated with the read/listened first chapter and second chapter, improving information exposure rate of the skipped third chapter, also improving continuity of book content to a certain extent, thereby improving the user's interest in the skipped third chapter, and further improving the probability of continuously reading the book and the user experience.

In some embodiments, the chapter key information determination module 820 is specifically configured to:
acquire first chapter information of the first chapter, second chapter information of the second chapter and the third chapter information of the third chapter;
extract, from the third chapter information, target information having an association with the first chapter information and the second chapter information, and generate the chapter key information based on the target information.

Further, the chapter key information determination module 820 is specifically configured to:
respectively extract, from the first chapter information and the second chapter information, first information and second information corresponding to a target information dimension; wherein, the target information dimension comprises at least one of core content, role, plot, scene, event or comment;
extract the target information from the third chapter information; wherein, the target information is used for transitioning the first information to the second information.

In some embodiments, the chapter key information display module 830 is specifically configured to:
in the table of content page, zoom in a table of content display area corresponding to the third chapter and display the chapter key information in the zoomed-in table of content display area;
or, the displaying the chapter key information of the third chapter in the table of content page comprises:
displaying a keyword control corresponding to the chapter key information in the table of content display area corresponding to the third chapter of the table of content page;
in response to a trigger operation on the keyword control, displaying the chapter key information in a target area corresponding to the table of content display area; wherein, the target area comprises a floating window, a floating layer region or the table of content display area expanded along a preset direction.

In some embodiments, the book information display apparatus 800 further comprises a local key information display module configured to:
after the presenting the table of content page of the book in response to the target trigger operation, acquire local key information of a target chapter; wherein, the local key information is extracted from chapter information corresponding to uncompleted content of the target chapter, and the target chapter comprises at least one of the first chapter or the second chapter; and
display the chapter progress and the local key information of the target chapter in the table of content page.

In some embodiments, the table of content page presentation module 810 is specifically configured to:
present the table of content page in response to a trigger operation on a table of content control displayed in a first content page;
accordingly, the book information display apparatus 800 further comprises a page return module configured to:
after displaying the chapter key information of the third chapter in the table of content page, in response to a trigger operation on the table of content page, display a second content page, and display a return control at a preset position of the second content page; and
in response to a trigger operation on the return control, redisplay the first content page.

In some embodiments, the page return module is specifically configured to:
in response to a trigger operation on any chapter in the table of content page, display the second content page corresponding to the triggered chapter; or
in response to a trigger operation on a note control displayed in the table of content page, display at least one note content corresponding to the book; and
in response to a trigger operation on the note content, display the second content page corresponding to the triggered note content.

In some embodiments, the page return module is further configured to:
after displaying the second content page in response to the trigger operation on the table of content page, and displaying the return control at the preset position of the second content page, if no trigger operation on the return control is detected within a preset duration, hide the return control.

In some embodiments, the book information display apparatus 800 further comprises a table of content display module configured to:
after presenting the table of content page of the book in response to the target trigger operation, if it is determined that a chapter progress of any chapter in the book is a completed progress, determine a table of content display style to be a first display style;
if it is determined that the chapter progress of any chapter is an intermediate progress that has been started but not completed, determine the table of content display style to be a second display style;
if it is determined that any chapter does not have a chapter progress, determine the table of content display style to be a third display style; wherein, the second display style, the third display style and the first display style decreases successively in highlight effects;
wherein, in the table of content page, any chapter is displayed in the table of content display style.

The book information display apparatus according to some embodiments of the present disclosure can execute the book information display method according to any embodiment of the present disclosure, and has corresponding functional modules and beneficial effects of executing the method.

It should be noted that, the modules included in the embodiments of the book information display apparatus are only divided according to functional logic, but are not limited to the above division, as long as the corresponding functions can be realized; in addition, specific names of the functional modules are only used for distinguishing one functional module from another, and are not used for limiting the protection scope of the present disclosure. The modules described above may be implemented as software components executing on one or more general-purpose processors, or may be implemented as hardware, such as programmable logic devices and/or application specific integrated circuits, for performing certain functions. In some embodiments, the modules may be embodied in the form of a software product, which may be stored on a non-volatile storage medium. These non-volatile storage media comprise instructions to cause a computer device (e.g., a personal computer, server, network device, mobile terminal, etc.) to perform the methods described in the embodiments of the present disclosure. In some embodiments, the modules described above may also be implemented on a single device or may be distributed across multiple devices. The functions of these modules may be combined with each other, or further divided into a plurality of sub-modules.

Some embodiments of the present disclosure also provide an electronic device that may comprise a processor, and a memory configured to store executable instructions. The processor may be configured to read the executable instructions from the memory and execute the executable instructions to implement the book information display method in the foregoing embodiments.

FIG. 9 shows a schematic structural diagram of an electronic device according to some embodiments of the present disclosure.

As shown in FIG. 9, the electronic device 900 may comprise a processing means (e.g., a central processing unit, a graphics processor, etc.) 901, which may perform various appropriate actions and processes according to a program stored in a Read-Only Memory (ROM) 902 or a program loaded from a storage means 908 into a Random Access Memory (RAM) 903. In the RAM 903, various programs and data necessary for the operation of the electronic device 900 are also stored. The processing means 901, ROM 902, and RAM 903 are connected to each other via a bus 904. An input/output interface (I/O interface) 905 is also connected to the bus 904.

Generally, the following means may be connected to the I/O interface 905: input means 906 including, for example, a touch screen, touch pad, keyboard, mouse, camera, microphone, accelerometer, gyroscope, etc.; an output means 907 including, for example, a Liquid Crystal Display (LCD), a speaker, a vibrator, and the like; storage means 908 including, for example, magnetic tape, hard disk, etc.; and a communication means 909. The communication means 909 may allow the electronic device 900 to communicate with other devices wirelessly or by wire to exchange data.

It should be noted that, the electronic device 900 shown in FIG. 9 is only an example, and should not bring any limitation to the functions and the use scope of the embodiments of the present disclosure. That is, while FIG. 9 illustrates an electronic device 900 having various means, it is to be understood that not all illustrated means are required to be implemented or provided. More or fewer means may be alternatively implemented or provided.

In particular, the processes described above with reference to the flowcharts may be implemented as computer software programs, according to the embodiments of the present disclosure. For example, an embodiment of the present disclosure includes a computer program product comprising a computer program carried on a non-transitory computer readable medium, the computer program containing program code for performing the method illustrated by the flowchart. In such an embodiment, the computer program may be downloaded and installed from a network through the communication means 909, or installed from the storage means 908, or installed from the ROM 902. When executed by the processing means 901, the computer program performs the above-described functions defined in the book information display method according to any of the embodiments of the present disclosure.

Some embodiments of the present disclosure further provide a computer-readable storage medium storing a computer program, which, when executed by a processor, causes the processor to implement the book information display method in any of the embodiments of the present disclosure.

It should be noted that, the computer readable medium of the present disclosure may be a computer readable signal medium or a computer readable storage medium or any combination of the two. The computer readable storage medium may be, for example, but not limited to, an electronic, magnetic, optical, electromagnetic, infrared, or semiconductor system, apparatus, or device, or any combination of the foregoing. More specific examples of the computer readable storage medium may include, but are not limited to: an electrical connection having one or more wires, a portable computer diskette, a hard disk, a Random Access Memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, a computer readable storage medium may be any tangible medium that can contain, or store a program for use by or in connection with an instruction execution system, apparatus, or device. In contrast, in the present disclosure, the computer readable signal medium may include a propagated data signal with computer readable program code embodied therein, in baseband or as part of a carrier wave. Such a propagated data signal may take any of a variety of forms, including, but not limited to, electro-magnetic, optical, or any suitable combination thereof. The computer readable signal medium may also be any computer readable medium other than the computer readable storage medium and can communicate, propagate, or transport a program for use by or in connection with an instruction execution system, apparatus, or device. Program code embodied on the computer readable medium may be transmitted using any appropriate medium, including but not limited to: electrical wires, optical cables, RF (radio frequency), etc., or any suitable combination of the foregoing.

In some embodiments, the clients, servers may communicate using any currently known or future developed network protocol, such as the Hypertext Transfer Protocol (HTTP), and may be interconnected with any form or medium of digital data communication (e.g., a communication network). Examples of communication networks include a local area network (“LAN”), a wide area network (“WAN”), internet (e.g., the Internet), and peer-to-peer networks (e.g., ad hoc peer-to-peer networks), as well as any currently known or future developed network.

The above computer readable medium may be embodied in the electronic device; or may be separate and not assembled into the electronic device.

The above computer-readable medium carries one or more programs, which, when executed by the electronic device, cause the electronic device to perform the book information display method described in any embodiment of the present disclosure.

In some embodiments of the present disclosure, computer program code for carrying out operations of the present disclosure may be written in one or more programming languages or any combination thereof, the above programming language includes but is not limited to an object oriented programming language such as Java, Smalltalk, C++, or a conventional procedural programming language such as the “C” language or similar programming languages. The program code may execute entirely on a user's computer, partly on a user's computer, as a stand-alone software package, partly on a user's computer and partly on a remote computer, or entirely on a remote computer or server. In case where a remote computer is involved, the remote computer may be connected to the user's computer through any type of network, including a Local Area Network (LAN) or a Wide Area Network (WAN), or the connection may be made to an external computer (for example, through the Internet using an Internet service provider).

Some embodiments of the present disclosure further provide a computer program product comprising: instructions which when executed by a processor, cause the processor to implement the book information display method in any of the embodiments of the present disclosure.

Some embodiments of the present disclosure further provide a computer program product comprising: instructions which when executed by a processor, cause the processor to implement the book information display method in any of the embodiments of the present disclosure.

The flowchart and block diagram in the figures illustrate the architecture, functionality, and operation of possible implementations of the apparatus, method and computer program product according to various embodiments of the present disclosure. In this regard, each block in the flowchart or block diagram may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in a reverse order, depending upon the functionality involved. It will also be noted that each block of the block diagram and/or flowchart, and combinations of blocks in the block diagram and/or flowchart, can be implemented by special purpose hardware-based systems that perform the specified functions or actions, or combinations of special purpose hardware and computer instructions.

The functions described herein above may be performed, at least in part, by one or more hardware logic components. For example, without limitation, exemplary types of the hardware logic components that may be used include: Field Programmable Gate Array (FPGA), Application Specific Integrated Circuit (ASIC), Application Specific Standard Product (ASSP), system on chip (SOC), Complex Programmable Logic Device (CPLD), and the like.

In the context of this disclosure, the machine-readable medium may be a tangible medium that can contain, or store a program for use by or in connection with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific examples of the machine-readable storage medium would include an electrical connection based on one or more wires, a portable computer diskette, a hard disk, a Random Access Memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

The above only describes the preferred embodiments of the present disclosure and the technical principles employed. It should be appreciated by those skilled in the art that the disclosure scope involved in the present disclosure is not limited to the technical solutions formed by specific combinations of the technical features described above, but also encompasses other technical solutions formed by arbitrary combinations of the above technical features or equivalent features thereof without departing from the above disclosed concepts, for example, a technical solution formed by performing mutual replacement between the above features and technical features having similar functions to those disclosed (but not limited to) in the present disclosure.

Furthermore, while operations are depicted in a specific order, this should not be understood as requiring that these operations be performed in the specific order shown or in a sequential order. Under certain circumstances, multitasking and parallel processing might be advantageous. Similarly, while several specific implementation details are included in the above discussion, these should not be construed as limitations on the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in language specific to structural features and/or method logical actions, it should be understood that the subject matter defined in the attached claims is not necessarily limited to the specific features or actions described above. Rather, the specific features and actions described above are only example forms of implementing the claims.

What is claimed is:

1. A book information display method, comprising:
presenting a table of content page of a book in response to a target trigger operation;
in response to detecting that a first chapter and a second chapter in the book which have chapter progresses are not consecutive, determining chapter key information corresponding to a third chapter; wherein, the third chapter is an unstarted chapter between the first chapter and the second chapter, and the chapter key information comprises information extracted from third chapter information of the third chapter and associated with the first chapter and the second chapter; and
displaying the chapter key information of the third chapter in the table of content page.

2. The method according to claim 1, wherein, the determining chapter key information corresponding to the third chapter, comprises:
acquiring first chapter information of the first chapter, second chapter information of the second chapter and the third chapter information of the third chapter; and
extracting, from the third chapter information, target information having an association with the first chapter information and the second chapter information, and generating the chapter key information based on the target information.

3. The method according to claim 2, wherein, the extracting, from the third chapter information, the target information having the association with the first chapter information and the second chapter information, comprises:
respectively extracting, from the first chapter information and the second chapter information, first information and second information corresponding to a target information dimension; and
extracting the target information from the third chapter information; wherein, the target information is configured for transitioning the first information to the second information.

4. The method according to claim 3, wherein, the target information dimension comprises at least one of core content, role, plot, scene, event or comment.

5. The method according to claim 1, wherein, the displaying the chapter key information of the third chapter in the table of content page, comprises:
in the table of content page, zooming in a table of content display area corresponding to the third chapter and displaying the chapter key information in the zoomed-in table of content display area;
or, the displaying the chapter key information of the third chapter in the table of content page, comprises:
displaying a keyword control corresponding to the chapter key information in the table of content display area corresponding to the third chapter of the table of content page; and
in response to a trigger operation on the keyword control, displaying the chapter key information in a target area corresponding to the table of content display area.

6. The method according to claim 5, wherein, the target area comprises a floating window, a floating layer region or the table of content display area expanded along a preset direction.

7. The method according to claim 1, wherein, after the presenting the table of content page of the book in response to the target trigger operation, the method further comprises:
acquiring local key information of a target chapter; wherein, the local key information is extracted from chapter information corresponding to uncompleted content of the target chapter, and the target chapter comprises at least one of the first chapter or the second chapter; and
displaying the chapter progress and the local key information of the target chapter in the table of content page.

8. The method according to claim 1, wherein, the presenting the table of content page of the book in response to the target trigger operation, comprises:
presenting the table of content page in response to a trigger operation on a table of content control displayed in a first content page; and
after the displaying the chapter key information of the third chapter in the table of content page, the method further comprises:
displaying a second content page in response to a trigger operation on the table of content page, and displaying a return control at a preset position of the second content page; and
in response to a trigger operation on the return control, redisplaying the first content page.

9. The method according to claim 8, wherein, the displaying the second content page in response to the trigger operation on the table of content page, comprises:
in response to a trigger operation on any chapter in the table of content page, displaying the second content page corresponding to the triggered chapter; or
in response to a trigger operation on a note control displayed in the table of content page, displaying at least one note content corresponding to the book; and
in response to a trigger operation on the note content, displaying the second content page corresponding to the triggered note content.

10. The method according to claim 8, wherein, after the displaying the second content page in response to the trigger operation on the table of content page, and displaying the return control at the preset position of the second content page, the method further comprises:
if no trigger operation on the return control is detected within a preset duration, hiding the return control.

11. The method according to claim 1, wherein, after the presenting the table of content page of the book in response to the target trigger operation, the method further comprises:
in response to determining that the chapter progress of any chapter in the book is a completed progress, determining a table of content display style to be a first display style;
in response to determining that the chapter progress of any chapter is an intermediate progress that has been started but not completed, determining the table of content display style to be a second display style;
in response to determining that any chapter does not have the chapter progress, determining the table of content display style to be a third display style;
wherein, in the table of content page, any chapter is displayed in the table of content display style.

12. The method according to claim 11, wherein, the second display style, the third display style and the first display style decreases successively in highlight effects.

13. (canceled)

14. An electronic device, comprising:
a processor;
a memory configured to store executable instructions;
wherein, the processor is configured to read the executable instructions from the memory and execute the executable instructions to implement a book information display method, comprising:
presenting a table of content page of a book in response to a target trigger operation;
in response to detecting that a first chapter and a second chapter in the book which have chapter progresses are not consecutive, determining chapter key information corresponding to a third chapter; wherein, the third chapter is an unstarted chapter between the first chapter and the second chapter, and the chapter key information comprises information extracted from third chapter information of the third chapter and associated with the first chapter and the second chapter; and
displaying the chapter key information of the third chapter in the table of content page.

15. A non-transitory computer-readable storage medium storing a computer program which, when executed by a processor, causes the processor to implement a book information display method comprising:
presenting a table of content page of a book in response to a target trigger operation;
in response to detecting that a first chapter and a second chapter in the book which have chapter progresses are not consecutive, determining chapter key information corresponding to a third chapter; wherein, the third chapter is an unstarted chapter between the first chapter and the second chapter, and the chapter key information comprises information extracted from third chapter information of the third chapter and associated with the first chapter and the second chapter; and
displaying the chapter key information of the third chapter in the table of content page.

16-17. (canceled)

18. The electronic device of claim 14, wherein, the determining chapter key information corresponding to the third chapter, comprises:
acquiring first chapter information of the first chapter, second chapter information of the second chapter and the third chapter information of the third chapter; and
extracting, from the third chapter information, target information having an association with the first chapter information and the second chapter information, and generating the chapter key information based on the target information.

19. The electronic device according to claim 18, wherein, the extracting, from the third chapter information, the target information having the association with the first chapter information and the second chapter information, comprises:
respectively extracting, from the first chapter information and the second chapter information, first information and second information corresponding to a target information dimension; and
extracting the target information from the third chapter information; wherein, the target information is configured for transitioning the first information to the second information.

20. The electronic device according to claim 19, wherein, the target information dimension comprises at least one of core content, role, plot, scene, event or comment.

21. The electronic device according to claim 14, wherein, the displaying the chapter key information of the third chapter in the table of content page, comprises:
in the table of content page, zooming in a table of content display area corresponding to the third chapter and displaying the chapter key information in the zoomed-in table of content display area;
or, the displaying the chapter key information of the third chapter in the table of content page, comprises:
displaying a keyword control corresponding to the chapter key information in the table of content display area corresponding to the third chapter of the table of content page; and
in response to a trigger operation on the keyword control, displaying the chapter key information in a target area corresponding to the table of content display area.

22. The electronic device according to claim 21, wherein, the target area comprises a floating window, a floating layer region or the table of content display area expanded along a preset direction.

23. The electronic device according to claim 14, wherein, after the presenting the table of content page of the book in response to the target trigger operation, the method further comprises:
acquiring local key information of a target chapter; wherein, the local key information is extracted from chapter information corresponding to uncompleted content of the target chapter, and the target chapter comprises at least one of the first chapter or the second chapter; and
displaying the chapter progress and the local key information of the target chapter in the table of content page.
